(19) United States
(12) Patent Application Publication
(10) Pub. No.: US 2004/0001590 A1
(43) Pub. Date: Jan. 1, 2004

(54) Efficient elliptic curve double-and-add calculator

(76) Inventors: Anne Kirsten Eisentraeger, Berkeley, CA (US); Kristin Estella Lauter, Seattle, WA (US); Peter L. Montgomery, San Rafael, CA (US)

Correspondence Address: LEE & HAYES PLLC, 421 W RIVERSIDE AVENUE SUITE 500, SPOKANE, WA, 99201

(21) Appl. No.: 10/185,782

(22) Filed: Jun. 27, 2002

(51) Int. Cl. H04L 9/00

(52) U.S. Cl. 380/30

(57) ABSTRACT

An implementation of a technology, described herein, for facilitating cryptography and other security processing. At least one implementation, described herein, maximizes the speed and security of fast exponentiation. At least one implementation, described herein, employs exponentiation with optimized elliptic curve “double-and-add” techniques to maximize speed and security of cryptosystems. This abstract itself is not intended to limit the scope of this patent. The scope of the present invention is pointed out in the appending claims.

### TECHNICAL FIELD

This invention generally relates to a technology for facilitating cryptography and other security processing.

### BACKGROUND

Cryptographic systems—such as those of the Public-Key Infrastructure (PKI)—often involve raising elements of some “group” to large powers. Herein, the focus is on abelian groups, in which the group operation is commutative. Examples of “abelian groups” are the integers Z under ordinary addition, the positive real numbers under ordinary multiplication, and the points on an elliptic curve. The task of raising an element of some group to a (possibly large) integer power is called “exponentiation”. It is not uncommon for exponentiation to be a central and expensive part of many cryptographic protocols.

For example, let G be an abelian group written additively with identity O, with binary operator +, and with the inverse (negative) of an element P ε G denoted by −P. If P, Q ε G, then P−Q is shorthand for P+(−Q). If n is a positive integer, and P ε G, then define:

nP=P+P+ . . . +P

where there are n P's (and (n−1)+'s) on the right. Also define 0P=O. If n is a negative integer, then define nP=−((−n)P)=(−n)(−P). The group elements obey many familiar algebraic identities under these definitions. Those of ordinary skill in the field will be familiar with these definitions and other relevant definitions found in abstract algebra textbooks.

The process of computing nP given an integer n and an element P ε G is frequently termed exponentiation.

The following references discuss elliptic curves and exponentiation techniques in the context of cryptography:

The 3rd Workshop on Elliptic Curve Cryptography (ECC '99), held in Waterloo, Ontario, Canada. Nov. 1-3, 1999. (Selected slides available at http://cacr.math.uwaterloo.ca—select Conferences).

“Recommended Elliptic Curves for Federal Government Use”, in Appendix 6 to FIPS 186-2 “Digital Signature Standard (DSS), Jan. 27, 2000. (Search at http:/csrc.nist.gov/encryption).

IEEE Standard Specifications for Public-Key Cryptography, IEEE Std 1363-2000, IEEE Computer Society, Aug. 29, 2000.

D. M. Gordon, A survey of fast exponentiation methods, J. Algorithms, 27, 129-146, 1998.

Donald E. Knuth, “The Art of Computer Programming”, Volume 2, Seminumerical Algorithms, 3rd edition, Addison-Wesley, 1997.

Square and Multiply Method of Exponentiation

For example, let n be a positive integer and P ε G. To compute nP directly from its definition, one needs n−1 applications of +. The associativity of +(a requirement in the definition of a group) ensures that

(n₁±n₂)P=n₁P±n₂P

for arbitrary integers n₁ and n₂, where ± can denote + or −. [N. B. n₁±n₂ is regular integer addition/subtraction, whereas n₁P±n₂P=(n₁P)±(n₂P) denotes group addition/subtraction. A dark font is used for group elements and operators.

Binary techniques of exponentiation are well-known to those of ordinary skill in the art. The above cited references further explain binary techniques of exponentiation.

The square-and-multiply method, also known as the left-to-right binary method, is well-known to those of ordinary skill in the art and is described in the Knuth reference. It has three cases (assume n>0):

(i) If n=1, then nP=P;

(ii) If n>1 is even, say n=2 m where m≧1, then nP=2(mP);

(iii) If n>1 is odd, say n=2 m+1 where m≧1, then nP=2(mP)+P.

This computation of nP from P is free when n=1. If n>1, then 1≦m≦n/2. The technique is called recursively to get mP and that result is used to compute nP. This technique uses at most 2 floor(log₂(n)) evaluations of +, where floor(x) denotes the greatest integer not exceeding the real number x It is one of many fast methods of exponentiation.

For example, if

$$\begin{matrix}n = 1234567 \\ = 1048576 + 131072 + 32768 + 16384 + 4096 + 1024 + 512 + 128 + 4 + 2 + 1 \\ = {( 100101101011010000111 )}_{2} ,\end{matrix}$$

then the square-and-multiply technique successively computes kP for k=

2,

4,

8, 9,

18,

36, 37,

74, 75,

300,301,

602,

1204, 1205,

2410, 2411,

4822,

9644, 89645,

38580,

77160,

154320,

308640, 308641,

617282, 617283,

1234566, 1234567.

Each bit in the binary expansion of 1234567 (except the leading 1) corresponds to one line above. The lines corresponding to a 1-bit have a doubling (meaning the two operands to + are the same) followed by another +. The lines corresponding to a 0-bit have only a doubling. There are 20 doublings and 10 additional additions.

Elliptic Curves

Elliptic curves form one family of groups used for implementing cryptosystems. Their popularity is based primarily upon there being no sub-exponential methods known to attack them; therefore, a much smaller key length seems to be secure. However, a conventional drawback is that adding two points on an elliptic curve typically involves several expensive multiplication operations in the base field—meaning that it takes more time and resources to process a group operation.

For the purpose of secure communications, elliptic curves are sometimes used for implementations of the public-key infrastructure (PKI). In such a scenario, two network-connected nodes (such as a client and a server) might share a common elliptic curve and a base point. The two nodes perform a “key exchange”. This may be done to establish a secure communication channel, for example, when deciding on a secret key to use for a “block cipher”.

Typically, in order to accomplish a key exchange between such nodes, each node selects an element in the elliptic curve—such as the agreed point on the curve—and raises it to an apparently random and extraordinarily large power. The results are exchanged and the other party's immediate result is raised to the same large power. Although the intermediate results are exposed along the communications path, the ultimate results are secure because only the nodes know which “large powers” were used.

While forming nP, the square-and-multiply technique in the last section typically executes case (iii):

If n>1 is odd, say n=2m+1 where m≧1, then nP=2(mP)+P

about half of the time. One point (here mP) is doubled, and another point (here P) is added to (or subtracted from) the result.

The Challenge of Fast Exponentiation

Accordingly, it is a challenge to increase the speed and efficiency of cryptography, especially for secure communications (such as that within the PKI).

### SUMMARY

Described herein is a technology for facilitating cryptography and other security processing.

At least one implementation, described herein, advances the speed and security of fast exponentiation. At least one implementation, described herein, employs exponentiation with optimized elliptic curve “double-and-add” techniques to further advance speed and security of cryptosystems.

This summary itself is not intended to limit the scope of this patent. Moreover, the title of this patent is not intended to limit the scope of this patent. For a better understanding of the present invention, please see the following detailed description and appending claims, taken in conjunction with the accompanying drawings. The scope of the present invention is pointed out in the appending claims.

### BRIEF DESCRIPTION OF THE DRAWINGS

The same numbers are used throughout the drawings to reference like elements and features.

FIG. 1 is a flow diagram showing a methodological implementation described herein.

FIG. 2 is an example of a computing operating environment capable of implementing at least one embodiment (wholly or partially) described herein.

### DETAILED DESCRIPTION

In the following description, for purposes of explanation, specific numbers, materials and configurations are set forth in order to provide a thorough understanding of the present invention. However, it will be apparent to one skilled in the art that the present invention may be practiced without the specific exemplary details. In other instances, well-known features are omitted or simplified to clarify the description of the exemplary implementations of present invention, thereby better explain the present invention. Furthermore, for ease of understanding, certain method steps are delineated as separate steps; however, these separately delineated steps should not be construed as necessarily order-dependent in their performance.

The following description sets forth one or more exemplary implementations of an Efficient Elliptic Curve Double-and-Add Calculator that incorporate elements recited in the appended claims. These implementations are described with specificity in order to meet statutory written description, enablement, and best-mode requirements. However, the description itself is not intended to limit the scope of this patent.

The inventors intend these exemplary implementations to be examples. The inventors do not intend these exemplary implementations to limit the scope of the claimed present invention. Rather, the inventors have contemplated that the claimed present invention might also be embodied and implemented in other ways, in conjunction with other present or future technologies.

An example of an embodiment of an Efficient Elliptic Curve Double-and-Add Calculator may be referred to as an “exemplary double-and-add calculator.”

Introduction

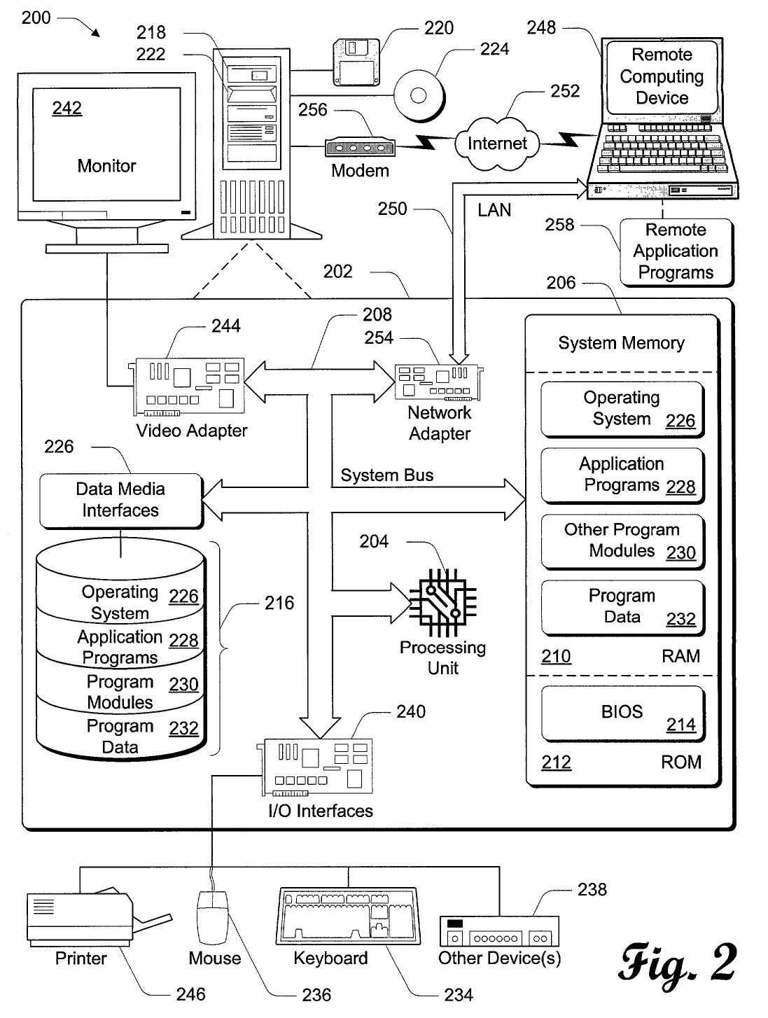

The exemplary double-and-add calculator may be implemented on computing systems and computer networks like that shown in FIG. 2. Although the exemplary double-and-add calculator may have many applications, cryptosystems and security are examples of particular applications.

Generally, the exemplary double-and-add calculator increases the speed and security of fast exponentiation calculation over that of conventional techniques. A user of the exemplary double-and-add calculator employs exponentiation (especially, those for elliptic curves) with optimized elliptic curve “double-and-add” techniques to advance the speed and security of cryptosystems.

Within cryptosystems (or other such security systems), exponentiation is repeatedly performed. The exemplary double-and-add calculator reduces the time to perform an exponentiation on a general elliptic curve. Experiments have shown a significant improvement in processing speed. For example, the improvement may be ten percent or more. This time savings is advantageous because the ratio of security level to computation time required to implement a cryptosystem is one of key practical factors when one is selecting a system within a particular context.

Elliptic Curve Arithmetic

For example, let K be a finite field. If K has characteristic not equal to 2 or 3, then an elliptic curve over K is given by an equation:

y²=x³+ax+b(a, b ε K, 4a³+27b²≠0). (Eₘₐᵢₙ)

Herein, the “main case” refers to characteristic 0 (zero) fields or fields of finite characteristic not equal to 2 (two) or 3 (three).

Equation (Eₘₐᵢₙ) is also used for curves over characteristic zero (0) fields. All fields of characteristic 0 (e.g., the real numbers) are infinite, so they are not is desirable for cryptography. However the techniques described herein apply to all (finite or infinite) fields of characteristic not equal to 2 or 3.

When K has characteristic 2, meaning 1+1=0, then an elliptic curve over K is given by an equation:

y²+xy=x³+ax²+b(a, b ε K, b ≠0). (Eₑᵥₑₙ)

Regardless of the characteristic, the group used for implementing a cryptosystem is the group of points on the curve over the field K, plus a point at infinity (called O), which serves as the group identity element. When represented in affine coordinates, all points except O have the form (x, y), where x, y ε K and they satisfy equation (Eₘₐᵢₙ) or (Eₑᵥₑₙ).

Points are added using a geometric group law which can be expressed algebraically through formulae for x and y. Whenever two points are added (P±Q), or a point is doubled (2P=P+P), these formulae are evaluated at the cost of some number of algebraic operations performed (over the base field). Specifically, such operations include multiplications, squarings, and divisions in the field.

For the sake of simplicity, the costs of performing field additions and subtractions are not counted because (for the fields of interest) those costs are substantially less that the cost of performing field multiplications, squarings, and divisions. The primary “cost” is the time of computation, but the cost may also include other resources (e.g., memory, registers, and other hardware dedicated to such computations).

Generally, this group arithmetic may be represented as follows: Suppose one is given two inputs P and Q, neither being O. In particular, suppose

P=(x₁, y₁) and Q=(x₂, y₂)

It is desirable to produce x₃ and y₃ so that

P+Q=(x₃, y₃).

When x₁≠x₂, the computations are:

| Main case: | Characteristic 2 case: |
|---|---|
| m = (y₂ − y₁)/(x₂ − x₁) | m = (y₂ − y₁)/(x₂ − x₁) |
| x₃ = m² − x₁ − x₂ | x₃ = m² + m − a − x₁ − x₂ |
| y₃ = −(y₁ + m(x₃ − x₁)) | y₃ = −x₃ − (y₁ + m(x₃ − x₁)) |

When P=(x₁, y₁)=(x₂, y₂)=Q, the above computations would set m=0/0. To avoid division by zero when doubling a point, m is set to the slope of the tangent line at P (obtained by applying implicit differentiation to equation (Eₘₐᵢₙ) or (Eₑᵥₑₙ)). That is

| Main case: | Characteristic 2 case: |
|---|---|
| m = (3 x₁² + a)/(2y₁) | m = x₁ + y₁/x₁ |

The formulae for x₃ and y₃ are unchanged. When this denominator of m vanishes (i.e., y₁=0 in the main case, or x₁=0 in the characteristic 2 case), the numerator cannot also vanish, so the slope is infinite and P+Q=O (point at infinity).

This result (P+Q=O) also holds when x₁=x₂ but y₁≠y₂.

To form P−Q=P+(−Q) rather than P+Q, one can negate Q first. That is, replace (x₂, y₂) by (x₂, −y₂) (characteristic not equal to 2 or 3) or by (x₂, −x₂−y₂) (characteristic 2 case). Add the result to P=(x₁, y₁).

In general, to add two points (P±Q), it costs one multiplication, one squaring, and one division in the field, whether in the main case or in the characteristic 2 case. To double a point (2P), it costs the same amount as an addition when the field has characteristic 2, but it costs an extra squaring in the main case (not counting multiplications by 2 or 3). This is summarized in the table below.

Performing 2P±Q with the exemplary double-and-add calculator saves at least one multiplication over the conventional techniques. That savings is summarized in the bottom line of the table below. (When the costs depend upon the characteristic, both costs are listed, with the cost for the main case preceding “or”):

Costs of Double-and-Add Calculations

| | Multiplications | Squarings | Divisions |
|---|---|---|---|
| Adding (P ± Q) | 1 | 1 | 1 |
| Doubling (2P) | 1 | 2 or 1 | 1 |
| Conventional 2P ± Q | 2 | 3 or 2 | 2 |
| New* 2P ± Q | 1 | 2 | 2 |

*= “new” refers to the 2P ± Q calculations of the exemplary double-and-add calculator.

Combined Double-and-Add Operation

The exemplary double-and-add calculator saves time by reducing the cost of a combined double and add. Herein, the label “double-and-add” implicitly includes both “double and add” operations and “double and subtract” operations, unless the context distinguishes them.

If P and Q are points on an elliptic curve, then it computes 2P+Q or 2P−Q more efficiently than the conventional method of doubling P and then adding (or subtracting) Q. In particular, when using affine coordinates, it eliminates a field multiplication. In the main case, it also saves a squaring operation that is necessary when employing conventional techniques.

The combination of operations in which a point (e.g., P) is doubled and then another point (e.g., Q) is added to the result (or subtracted from the result) is called a “double-and-add” operation herein. During some exponentiation techniques, such as square-and-multiply method mentioned earlier, the double-and-add operation is needed numerous times.

The exemplary double-and-add calculator performs a doubling and an addition, (2P±Q), using at most 1 multiplication, 2 squarings, and 2 divisions, except that 2P+P=2P−(−P) takes a third squaring in the main case. This is, at least, one fewer multiplication than conventional techniques. It usually saves a squaring in the main case.

Firstly, instead of performing the doubling of P followed by the adding of Q, the exemplary double-and-add calculator adds P to the result of adding P to Q (or subtracting Q from P). In other words, instead of performing (2P)±Q, the exemplary double-and-add calculator performs (P±Q)+P. It exploits the associativity of elliptic curve addition.

Generally, that may be represented as follows:

(x₁, y₁)=P

(x₂, y₂)=Q

(x₃, y₃)=P+Q=S

$$\begin{matrix}( {x}_{4} , {y}_{4} ) = ( {x}_{3} , {y}_{3} ) + ( {x}_{1} , {y}_{1} ) = T \\ = ( P + Q ) + P \\ = 2 P + Q = T\end{matrix}$$

On its face and by itself, such a replacement of an operation with one or more equivalent operations may not result in cost savings, such as is contemplated herein. However, as part of this conversion, the exemplary double-and-add calculator replaces a doubling (2P) by a general addition, which saves a squaring in the main case.

Moreover, the exemplary double-and-add calculator recognizes a redundancy within the field calculations in the combined (P±Q)+P operations that does not exist when performing 2P±Q operations. In particular, the exemplary double-and-add calculator recognizes that is unnecessary to calculate the y-coordinate of P±Q.

The following illustrates why the calculation of y₃ in P±Q=(x₃, y₃) is not necessary with the exemplary double-and-add calculator. After

| Main case: | Characteristic 2 case: |
|---|---|
| (compute suitable m) | (compute suitable m) |
| x₃ = m² − x₁ − x₂ | x₃ = m² + m − a − x₁ − x₂ |
| y₃ = −(y₁ + m(x₃ − x₁)) | y₃ = −x₃ − (y₁ + m(x₃ − x₁)) |

it remains to add P=(x₁, y₁) to P±Q=(x₃, y₃). It is known that these points are distinct (because Q≠O is assumed). The next step needs the (possibly infinite) slope m′=(y₃−y₁)/(x₃−x₁) through these points. Both above formulae for y₃ include a −m(x₃−x₁) contribution, but y₃ is later divided by x₃−x₁ within the m′ computation.

The m′ computation is replaced by

| Main case: | Characteristic 2 case: |
|---|---|
| m′ = (−2y₁)/(x₃ − x₁) − m | m′ = x₃/(x₃ − x₁) − m |

Compared to the earlier m′=(y₃−y₁)/(x₃−x₁), these formulae for m′ still need one division. The improvement is that they no longer reference y₃ directly. This y₃ is used nowhere else in the (P±Q)+P computation. Suppressing its computation avoids the multiplication m(x₃−x₁), and reduces the overall cost by one multiplication.

Stated another way:

Where P=(x₁, y₁) and Q=(x₂, y₂), the exemplary double-and-add calculator first finds P±Q, except the exemplary double-and-add calculator saves the slope (m above) and omits the y-coordinate of P±Q (which is y₃ above) because the y-coordinate is not needed for the next calculation. This saves a field multiplication. Next, the exemplary double-and-add calculator finds (P±Q)+P. So one has done two additions and saved one point multiplication. In the main case, a squaring is saved because the order of the operations avoided a point doubling.

Triple a Point (3P)

The exemplary double-and-add calculator may be used to compute the triple of a point: 3P. In this instance, 3P is calculated as (P+P)+P, where the earlier Q has been replaced with a P.

M-Tuple-and-Add Operations

The double-and-add concept may be extended to operations called “m-tuple-and-add” operations, where m is 2 or more. Examples of such m-tuple-and-add operations include “triple-and-add” (3P±Q), “quadruple-and-add” (4P±Q) “quintuple-and-add” (5P±Q), and so forth. With m-tuple-and-add operations, additional time savings may be achieved by reducing multiplication operations that are necessary when employing conventional techniques. These m-tuple-and-add operations occur frequently when the exponent is written in m-ary (e.g., tertiary, quadiary, quintiary, etc.) form and exponentiation (such as left-to-right exponentiation) is employed.

Comparison to Conventional Exponentiation

Suppose one would like to compute kP given an exponent k with n bits. For this comparison, assume we are in the main case, and that the relative costs of field operations are 1 unit per squaring or general multiplication and 5 units per division.

Comparison One

The conventional left-to-right binary technique of exponentiation with a window size of 1 needs about n elliptic curve doublings, of which a fraction ε=½ are followed immediately by an addition, if about ε of the bits are 1's. So we have to perform ε*n additions. Conventional techniques for group arithmetic would need about 2n+ε*n field squarings, n+ε*n field general multiplications, and n+ε*n field divisions. The overall cost is

(2n+ε*n)+(n+ε*n)+5(n+ε*n)=8n+7ε*n

This computation includes ε*n sub-computations of the form 2P₁+P₂. Writing each as (P₁+P₂)+P₁ saves one squaring per sub-computation, reducing the overall cost to 8n+6ε*n.

However, the exemplary double-and-add calculator saves another multiplication per sub-computation, dropping the overall cost to 8n+5ε*n. When ε=0.5, the drop from 8n+7ε*n to 8n+5ε*n is a reduction from 11.5 n to 10.5 n. In this example, this results show an improvement in processing speed in the neighborhood of nine percent over the conventional techniques.

Comparison Two

When the window size is increased to 2, and one assumes that 2 P and 3 P have been precomputed, one performs n/2 computations of the form 4P₁. Thus, n doublings are performed. However, three quarters of these quadruplings are immediately followed by an addition, because the only case in which an addition was not performed is the case when the next two digits in the binary expansion of k are both zero. That occurs only a quarter of the cases.

Consequently, a total of (⅜)n additions is performed using the conventional techniques, so ε=⅜ in this case. The overall cost for the conventional technique with window size 2 is 8n+7ε*n=10.625 n.

However, the exemplary double-and-add calculator drops the overall cost to 8n+5ε*n=9.875 n. In this example, this results show an improvement in processing speed in the neighborhood of seven percent over the conventional techniques.

Demonstrations Using Examples

The following are examples using the left-to-right technique of binary exponentiation which demonstrate the conventional (naive) techniques and the techniques of the exemplary double-and-add calculator:

1133129P=(100010100101001001001)₂P

This may be computed as follows:

TEMP=P

TEMP=16TEMP+P

TEMP=32TEMP+9P

TEMP=32TEMP+9P

TEMP=64TEMP+9P

For comparison, the following tables illustrate the number of operations needed (a=group adds, d=group doublings, div=field divisions , s=field squarings, m=field multiplications) to perform the left-to-right technique of binary exponentiation using the conventional (naive) techniques and the techniques of the exemplary double-and-add calculator

Using the Conventional (i.e., Naive) Techniques:

| Steps of left-to-right exp | Curve operations | Field operations |
|---|---|---|
| TEMP = P | | |
| TEMP = 16TEMP + P | 4d + 1a | 5div + 9s + 5m |
| TEMP = 32TEMP + 9P | 5d + 1a | 6div + 11s + 6m |
| TEMP = 32TEMP + 9P | 5d + 1a | 6div + 11s + 6m |
| TEMP = 64TEMP + 9P | 6d + 1a | 7div + 13s + 7m |
| TOTAL | 20d + 4a | 24div + 44s + 24m |

Using the Exemplary Double-And-Add Calculator:

| | | Group | Field | |
|---|---|---|---|---|
| Left-to-right exp | Curve operations | operations | operations | Savings |
| TEMP = P | | | | |
| TEMP = 16TEMP + P | (8TEMP + P) + | 3d + 2a | 5div + 8s + 4m | 1s & 1m |
| | 8TEMP | | | |
| TEMP = 32TEMP + P | (16TEMP + P) + | 4d + 2a | 6div + 10s + 5m | 1s & 1m |
| | 16TEMP | | | |
| TEMP = 32TEMP + P | (16TEMP + P) + | 4d + 2a | 6div + 10s + 5m | 1s & 1m |
| | 16TEMP | | | |
| TEMP = 64TEMP + P | (32TEMP + P) + | 5d + 2a | 7div + 12s + 6m | 1s & 1m |
| | 32TEMP | | | |
| TOTAL | | 16d + 8a | 24div + 40s + 2m | 4s & 4m |

With this example, the techniques of the exemplary double-and-add calculator save 4 squarings and 4 multiplications compared to the conventional (i.e., naive) techniques.

Using m-Ary Expansion

Another way to save is to use a m-ary expansion, where m is 3 or greater. For example, use a ternary expansion and use the left-to-right technique. This gives (2010120100202)₃*P, which can be computed as follows using the exemplary double-and-add calculator:

| | | Group | Field | |
|---|---|---|---|---|
| Left-to-right exp | Curve operations | operations | operations | Savings |
| TEMP = 6P | | | | |
| TEMP = 9TEMP + 3P | 3(3TEMP) + 3P | 1d + 4a | 5div + 6s + 3m | 2s & 2m |
| TEMP = 27TEMP + 15P | 3(9TEMP) + 15P | 2d + 5a | 7div + 9s + 5m | 2s & 2m |
| TEMP = 27TEMP + 9P | 3(9TEMP) + 9P | 2d + 5a | 7div + 9s + 5m | 2s & 2m |
| TEMP = 27TEMP + 20P | 3 (9TEMP) + 20 P | 2d + 5a | 7div + 9s + 5m | 2s & 2m |
| TOTAL | | 7d + 19a | 26div + 33s + 1m | 8s & 8m |

This assumes that small multiples of the point have been precomputed. It uses 9*TEMP=3*(3*TEMP), which takes 2 doubles and 2 adds and saves an extra multiplication twice.

Pseudo-Code for 2P+Q, General Case

For example, let P and Q be points on an elliptic curve (Eₘₐᵢₙ) or (Eₑᵥₑₙ) using affine coordinates. Here is pseudocode for an implementation that calculates 2P±Q using techniques of the exemplary double-and-add calculator, including exceptional cases. The notations x(P) and y(P) denote the x- and y-coordinates of P (unless P=O), and likewise for other arguments to x, y.

/* General case code for 2P±Q., where

P=(x₁, y₁) and Q=(x₂, y₂)*/

if (P = O) then

return ±Q;

else if (Q = O) then

Use conventional technique for 2P; else

y₂′ = (y-coordinate of ±Q)
if (x1 ≠ x2) then

m = (y₁ − y₂′) / (x₁ − x₂);

/* m is the slope of line through P, ±Q */

else if (y₁ ≠ y₂′) then

return P;

/* P and ±Q are negatives, so 2P ± Q = P */

else if (characteristic 2) then

m = x₁ + y₁/x₁;

/* P = Q tangent slope */

else

m = (3x₁² + a) / (2y₁);

/* P = Q tangent slope */

end if

/* Build (x₃, y₃) = P ± Q, but don't

compute y₃ explicitly. */

/* Then build (x₄, y₄) = 2P ± Q. */

if (characteristic 2) then

x₃ = m² + m − a − x₁ − x₂;

/* Think y₃ = x₃ + y₁ + m(x₃ − x₁); */

if (x₃ = x₁) then

return O;

/* P±Q and P cannot be same point,

must be negatives */

end if;

/* Think m′ = (y₃ − y₁) / (x₃ − x₁) */

m′ = m + x₃/(x₃ − x₁);
x₄ = (m′)² + m′ − a − x₃ − x₁;
y₄ = x₄ + y₁ + m′ (x₃ − x₁);

else

x₃ = m² − x₁ − x₂;

/* Think y₃ = −[y₁ + m(x₃ − x₁)] */

if (x₃ = x₁) then

return O; /* P±Q and P must be negatives */

end if;

/* Think m′ = (y₃ − y₁) / (x₃ − x₁) */

m′ = −(2y₁)/(x₃ − x₁) − m; /* or compute −m′ */

x₄ = (m′)² − x₃ − x₁;
y₄ = −[y₁ + m′(x₄ − x₁)];

end if;
return (x₄, y₄);

end if;

Another Application of Double-and-Add

Another use of double-and-add is multiple exponentiation, such as n₁P₁+n₂P₂+n₃P₃, where the three exponents n₁, n₂, n₃ have approximately the same length. After creating an 8-entry table with

O, P₁, P₂, P₂+P₁, P₃, P₃+P₁, P₃+P₂, P₃+P₂+P₁,

one squaring and one multiplication are needed per table entry, per bit in the exponents. About ⅞ of the doublings will be followed by an addition.

If we want 29P₁+44P₂, for example, write both exponents as 6-bit binary numbers: (011101)₂ and (101100)₂. Scanning these left-to-right, the steps are

| Bits | Table entry | Action |
|---|---|---|
| 0,1 | P₂ | T := P₂ |
| 1,0 | P₁ | T := 2T + P₁ = P₁ + 2P₂ |
| 1,1 | P₁ + P₂ | T := 2T + (P₁ + P₂) = 3P₁ + 5P₂ |
| 1,1 | P₁ + P₂ | T := 2T + (P₁ + P₂) = 7P₁ + 11P₂ |
| 0,0 | 0 | T := 2T = 14P₁ + 22P₂ |
| 1,0 | P₁ | T := 2T + P₁ = 29P₁ + 44P₂ |

There is one addition (P₁+P₂) to construct the table, four doublings immediately followed by an addition, and one doubling without an addition. While doing 10 elliptic curve operations, the double-and-add of the exemplary double-and-add calculator is employed four times. Doing the exponents separately, say by the addition-subtraction chains

1, 2, 4, 8, 7, 14, 28, 29

1, 2, 4, 6, 12, 24, 48, 44

takes seven elliptic curve operations on each line, plus a final add (15 total).

Methodological Implementation of the Exemplary Double-and-Add Calculator

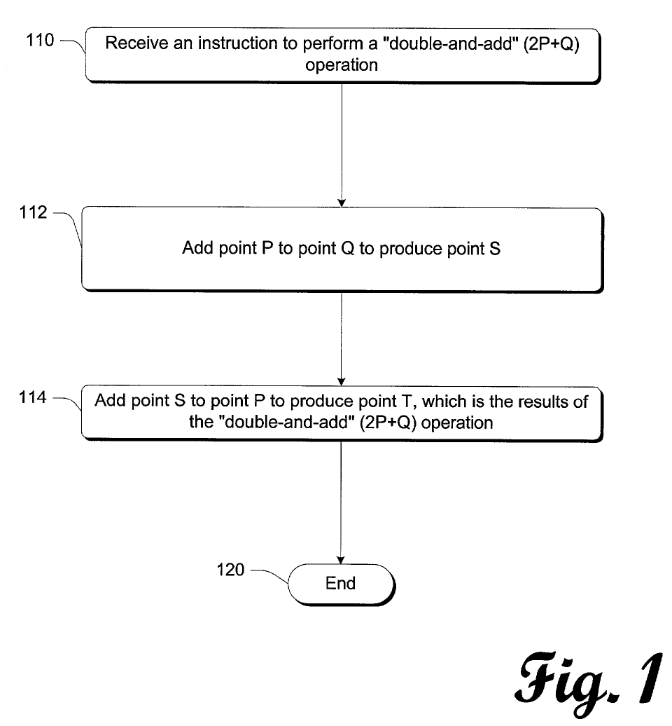

FIG. 1 shows a methodological implementation of the exemplary double-and-add calculator. This methodological implementation may be performed in software, hardware, or a combination thereof. An example of an application for this methodological implementation is efficient elliptic curve exponentiation within the realm of cryptosystems.

At 310, the exemplary double-and-add calculator receives an instruction to perform a “double-and-add” (2P±Q) operation. P and Q are points on an elliptic curve represented by (x₁, y₁) and (x₂, y₂), respectively.

At 312, the exemplary double-and-add calculator combines point P to point Q to produce point S. Such combination may be via addition or subtraction (as is appropriate). Point S is represented by (x₃, y₃). In so doing, not all of the coordinates of the point S are calculated. More specifically, the y-coordinate of point S (which is y₃) is not calculated.

At 314, the exemplary double-and-add calculator adds point S to point P to produce point T represented by (x₄, y₄), which is the result of the “double-and-add” (2P±Q) operation. More specifically, in the main case, the exemplary double-and-add calculator calculates m, m′, and the coordinates of point T=(x₄, y₄) as follows:

$$\begin{matrix}m = \frac{{y}_{1} - {y}_{2}}{{x}_{1} - {x}_{2}} \\ {m}^{′} = \frac{{y}_{3} - {y}_{1}}{{x}_{3} - {x}_{1}} = - m - \frac{2 {y}_{1}}{{x}_{3} - {x}_{1}}\end{matrix}$$

x₄=(m′)²−x₁−x₃

y₄=−[m′(x₄−x₁)+y₁].

The process ends at 320.

Exemplary Computing System and Environment

FIG. 2 illustrates an example of a suitable computing environment 200 within which an exemplary double-and-add calculator, as described herein, may be implemented (either fully or partially). The computing environment 200 may be utilized in the computer and network architectures described herein.

The exemplary computing environment 200 is only one example of a computing environment and is not intended to suggest any limitation as to the scope of use or functionality of the computer and network architectures. Neither should the computing environment 200 be interpreted as having any dependency or requirement relating to any one or combination of components illustrated in the exemplary computing environment 200.

The exemplary double-and-add calculator may be implemented with any of numerous other general purpose or special purpose computing system environments or configurations. Examples of well-known computing systems, environments, and/or configurations that may be suitable for use include, but are not limited to, personal computers, server computers, smartcards, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary double-and-add calculator may be described in the general context of computer-executable instructions, such as program modules, being executed by a computer. Generally, program modules include routines, programs, objects, components, data structures, etc. that perform particular tasks or implement particular abstract data types. The exemplary double-and-add calculator may also be practiced in distributed computing environments where tasks are performed by remote processing devices that are linked through a communications network. In a distributed computing environment, program modules may be located in both local and remote computer storage media including memory storage devices.

The computing environment 200 includes a general-purpose computing device in the form of a computer 202. The components of computer 202 may include, by are not limited to, one or more processors or processing units 204, a system memory 206, and a system bus 208 that couples various system components including the processor 204 to the system memory 206.

The system bus 208 represents one or more of any of several types of bus structures, including a memory bus or memory controller, a peripheral bus, an accelerated graphics port, and a processor or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 202 typically includes a variety of computer readable media. Such media may be any available media that are accessible by computer 202, a category that includes both volatile and non-volatile media, removable and non-removable media.

The system memory 206 includes computer readable media in the form of volatile memory, such as random access memory (RAM) 210, and/or non-volatile memory, such as read-only memory (ROM) 212. A basic input/output system (BIOS) 214, containing the basic routines that help to transfer information between elements within computer 202, such as during start-up, is stored in ROM 212. RAM 210 typically contains data and/or program modules that are immediately accessible to and/or presently operated on by the processing unit 204.

Computer 202 may also include other removable/non-removable, volatile/non-volatile computer storage media. By way of example, FIG. 2 illustrates a hard disk drive 216 for reading from and writing to a non-removable, non-volatile magnetic media (not shown), a magnetic disk drive 218 for reading from and writing to a removable, non-volatile magnetic disk 220 (e.g., a “floppy disk”), and an optical disk drive 222 for reading from and/or writing to a removable, non-volatile optical disk 224 such as a CD-ROM, DVD-ROM, or other optical media. The hard disk drive 216, magnetic disk drive 218, and optical disk drive 222 are each connected to the system bus 208 by one or more data media interfaces 226. Alternatively, the hard disk drive 216, magnetic disk drive 218, and optical disk drive 222 may be connected to the system bus 208 by one or more interfaces (not shown).

The disk drives and their associated computer-readable media provide non-volatile storage of computer-readable instructions, data structures, program modules, and other data for computer 202. Although the example illustrates a hard disk 216, a removable magnetic disk 220, and a removable optical disk 224, it is to be appreciated that other types of computer readable media which may store data that is accessible by a computer, such as magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like, may also be utilized to implement the exemplary computing system and environment.

Any number of program modules may be stored on the hard disk 216, magnetic disk 220, optical disk 224, ROM 212, and/or RAM 210, including by way of example, an operating system 226, one or more application programs 228, other program modules 230, and program data 232.

A user may enter commands and information into computer 202 via input devices such as a keyboard 234 and a pointing device 236 (e.g., a “mouse”). Other input devices 238 (not shown specifically) may include a microphone, joystick, game pad, satellite dish, serial port, scanner, and/or the like. These and other input devices are connected to the processing unit 204 via input/output interfaces 240 that are coupled to the system bus 208, but may be connected by other interface and bus structures, such as a parallel port, game port, or a universal serial bus (USB).

A monitor 242 or other type of display device may also be connected to the system bus 208 via an interface, such as a video adapter 244. In addition to the monitor 242, other output peripheral devices may include components such as speakers (not shown) and a printer 246 which may be connected to computer 202 via the input/output interfaces 240.

Computer 202 may operate in a networked environment using logical connections to one or more remote computers, such as a remote computing device 248. By way of example, the remote computing device 248 may be a personal computer, portable computer, a server, a router, a network computer, a peer device or other common network node, and the like. The remote computing device 248 is illustrated as a portable computer that may include many or all of the elements and features described herein relative to computer 202.

Logical connections between computer 202 and the remote computer 248 are depicted as a local area network (LAN) 250 and a general wide area network (WAN) 252. Such networking environments are commonplace in offices, enterprise-wide computer networks, intranets, and the Internet.

When implemented in a LAN networking environment, the computer 202 is connected to a local network 250 via a network interface or adapter 254. When implemented in a WAN networking environment, the computer 202 typically includes a modem 256 or other means for establishing communications over the wide network 252. The modem 256, which may be internal or external to computer 202, may be connected to the system bus 208 via the input/output interfaces 240 or other appropriate mechanisms. It is to be appreciated that the illustrated network connections are exemplary and that other means of establishing communication link(s) between the computers 202 and 248 may be employed.

In a networked environment, such as that illustrated with computing environment 200, program modules depicted relative to the computer 202, or portions thereof, may be stored in a remote memory storage device. By way of example, remote application programs 258 reside on a memory device of remote computer 248. For purposes of illustration, application programs and other executable program components such as the operating system are illustrated herein as discrete blocks, although it is recognized that such programs and components reside at various times in different storage components of the computing device 202, and are executed by the data processor(s) of the computer.

Computer-Executable Instructions

An implementation of an exemplary double-and-add calculator may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Exemplary Operating Environment

FIG. 2 illustrates an example of a suitable operating environment 200 in which an exemplary double-and-add calculator may be implemented. Specifically, the exemplary double-and-add calculator(s) described herein may be implemented (wholly or in part) by any program modules 228-230 and/or operating system 226 in FIG. 2 or a portion thereof.

The operating environment is only an example of a suitable operating environment and is not intended to suggest any limitation as to the scope or use of functionality of the exemplary double-and-add calculator(s) described herein. Other well-known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipments, general- and special-purpose appliances, application-specific integrated circuits (ASICs), network PCs, minicomputers, mainframe computers, distributed computing environments that include any of the above systems or devices, and the like.

Computer Readable Media

An implementation of an exemplary double-and-add calculator may be stored on or transmitted across some form of computer readable media. Computer readable media may be any available media that may be accessed by a computer. By way of example, and not limitation, computer readable media may comprise “computer storage media” and “communications media.”

“Computer storage media” include volatile and non-volatile, removable and non-removable media implemented in any technique or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embody computer-readable instructions, data structures, program modules, or other data in a modulated data signal, such as carrier wave or other transport mechanism. Communication media also include any information delivery media.

The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Conclusion

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-readable medium having computer-executable instructions that, when executed by a computer, performs a method facilitating the efficiency of a “double-and-add” operation, where P and Q are points on an elliptic curve, the method comprising:
combining point P and point Q to produce point S, wherein fewer than all of the coordinates of point S are determined;
combining point S and point P to produce point T.

2. A medium as recited in claim 1, wherein the combining of point P and point Q comprises adding point P to point Q.

3. A medium as recited in claim 1, wherein the combining of point P and point Q comprises subtracting one point from another.

4. A medium as recited in claim 1, wherein the combining point S to point P comprises adding point S to point P.

5. A medium as recited in claim 1, wherein a “double-and-add” operation, where P and Q are points on an elliptic curve, produces the point T.

6. A medium as recited in claim 1, wherein a y-coordinate of S is not determined but the slope of the line through P and ±Q is output along with the x-coordinate of S.

7. A medium as recited in claim 1, wherein during one or more of the combinations, m, m′, x₄, and y₄ are determined as follows:
$$\begin{matrix}m = \frac{{y}_{1} - {y}_{2}}{{x}_{1} - {x}_{2}} \\ {m}^{′} = \frac{{y}_{3} - {y}_{1}}{{x}_{3} - {x}_{1}} = - m - \frac{2 {y}_{1}}{{x}_{3} - {x}_{1}}\end{matrix}$$
x₄(m′)²−x₁−x₃
y₄=−[m′(x₄−x₁)+y₁]
wherein point P is represented by coordinates x₁, y₁; point Q is represented by coordinates x₂, y₂; point S is represented by coordinates x₃, y₃; point T is represented by coordinates x₄, y₄.

8. A medium as recited in claim 1, wherein the elliptic curve is defined over a field of characteristic 2.

9. A medium as recited in claim 1, wherein the elliptic curve is characterized by y²+xy=x³+ax²+b over a field of characteristic 2.

10. A medium as recited in claim 1, wherein the elliptic curve is defined over a field of characteristic 3.

11. A medium as recited in claim 1, wherein the elliptic curve is characterized by y²=x³+ax²+bx+c over a field of characteristic 3.

12. A medium as recited in claim 1, wherein the elliptic curve is defined over a field of odd characteristic not equal to 3.

13. A medium as recited in claim 1, wherein the elliptic curve is characterized by y²=x³+ax+b over a field of odd characteristic not equal to 3.

14. A medium as recited in claim 1, wherein the elliptic curve is characterized by y²=x³+ax+b over a field of characteristic 0.

15. A device comprising a computer-readable medium as recited in claim 1.

16. A computer-readable medium having computer-executable instructions that, when executed by a computer, performs a method facilitating the efficiency of a “double-and-add” operation, where P and Q are points on an elliptic curve, the method comprising:
combining point P and point Q to produce point S;
combining point S and point P to produce point T.

17. A medium as recited in claim 16, wherein at least one coordinate of the point S is not determined.

18. A medium as recited in claim 16, wherein the combining of point P and point Q comprises adding point P to point Q.

19. A medium as recited in claim 16, wherein the combining of point P and point Q comprises subtracting one point from another.

20. A medium as recited in claim 16, wherein the combining point S to point P comprises adding point S to point P.

21. A medium as recited in claim 16, wherein a “double-and-add” operation, where P and Q are points on an elliptic curve, produces the point T.

22. A medium as recited in claim 16, wherein a y-coordinate of S is not determined but the slope of the line through P and ±Q is output along with the x-coordinate of S.

23. A medium as recited in claim 16, wherein during one or more of the combinations, m, m′, x₄, and y₄ are determined as follows:
$$\begin{matrix}m = \frac{{y}_{1} - {y}_{2}}{{x}_{1} - {x}_{2}} \\ {m}^{′} = \frac{{y}_{3} - {y}_{1}}{{x}_{3} - {x}_{1}} = - m - \frac{2 {y}_{1}}{{x}_{3} - {x}_{1}}\end{matrix}$$
x₄=(m′)²−x₁−x₃
y₄=−[m′(x₄−x₁)+y₁]
wherein point P is represented by coordinates x₁, y₁; point Q is represented by coordinates x₂, y₂; point S is represented by coordinates x₃, y₃; point T is represented by coordinates x₄, y₄.

24. A medium as recited in claim 16, wherein the elliptic curve is defined over a field of characteristic 2.

25. A medium as recited in claim 16, wherein the elliptic curve is characterized by y²+xy=x³+ax²+b over a field of characteristic 2.

26. A medium as recited in claim 16, wherein the elliptic curve is defined over a field of characteristic 3.

27. A medium as recited in claim 16, wherein the elliptic curve is characterized by y²=x³+ax²+bx+c over a field of characteristic 3.

28. A medium as recited in claim 16, wherein the elliptic curve is defined over a field of characteristic not equal to 2 or 3.

29. A medium as recited in claim 16, wherein the elliptic curve is characterized by y²=x³+ax+b over a field of characteristic not equal to 2 or 3.

30. A medium as recited in claim 16, wherein the elliptic curve is characterized by y²=x²+ax+b over a field of characteristic 0.

31. A device comprising a computer-readable medium as recited in claim 16.

32. A computer-readable medium having computer-executable instructions that, when executed by a computer, performs a method facilitating the efficiency of a “double-and-add” operation with a collection of points on an elliptic curve, the method comprises combining multiples of one or more points of the collection to produce point S on the elliptic curve.

33. A medium as recited in claim 32, wherein at least one coordinate of the point S is not determined.

34. A medium as recited in claim 32, wherein the combining comprises adding multiples of one or more points of the collection on the elliptic curve.

35. A medium as recited in claim 32, wherein the combining comprises subtracting multiples of one or more points of the collection on the elliptic curve.

36. A medium as recited in claim 32, wherein the elliptic curve is defined over a field of characteristic 2.

37. A medium as recited in claim 32, wherein the elliptic curve is characterized by y²+xy=x³+ax²+b over a field of characteristic 2.

38. A medium as recited in claim 32, wherein the elliptic curve is defined over a field of characteristic 3.

39. A medium as recited in claim 32, wherein the elliptic curve is characterized by y²=x³+ax²+bx+c over a field of characteristic 3.

40. A medium as recited in claim 32, wherein the elliptic curve is defined over a field of characteristic not equal to 2 or 3.

41. A medium as recited in claim 32, wherein the elliptic curve is characterized by y²=x³+ax+b over a field of characteristic not equal to 2 or 3.

42. A medium as recited in claim 32, wherein the elliptic curve is characterized by y²=x³+ax+b over a field of characteristic 0.

43. A device comprising a computer-readable medium as recited in claim 32.

44. A method facilitating the efficiency of a “double-and-add” operation, where P and Q are points on an elliptic curve, the method comprising:
combining point P and point Q to produce point S, wherein fewer than all of the coordinates of point S are determined;
combining point S and point P to produce point T.

45. A method as recited in claim 44, wherein the combining of point P and point Q comprises adding point P to point Q.

46. A method as recited in claim 44, wherein the combining of point P and point Q comprises subtracting one point from another.

47. A method as recited in claim 44, wherein the combining point S to point P comprises adding point S to point P.

48. A method as recited in claim 44, wherein a “double-and-add” operation, where P and Q are points on an elliptic curve, produces the point T.

49. A method as recited in claim 44, wherein at least one coordinate of the point S is not determined.

50. A method as recited in claim 44, wherein a y-coordinate of S is not determined but the slope of the line through P and ±Q is output along with the x-coordinate of S.

51. A method as recited in claim 44, wherein during one or more of the combinations, m, m′, x₄, and y₄ are determined as follows:
$$\begin{matrix}m = \frac{{y}_{1} - {y}_{2}}{{x}_{1} - {x}_{2}} \\ {m}^{′} = \frac{{y}_{3} - {y}_{1}}{{x}_{3} - {x}_{1}} = - m - \frac{2 {y}_{1}}{{x}_{3} - {x}_{1}}\end{matrix}$$
x₄=(m′)²−x₁−x₃
y₄=−[m′(x₄−x₁)+y₁]
wherein point P is represented by coordinates x₁, y₁; point Q is represented by coordinates x₂, y₂; point S is represented by coordinates x₃, y₃; point T is represented by coordinates x₄, y₄.

52. A method as recited in claim 44, wherein the elliptic curve is defined over a field of characteristic 2.

53. A method as recited in claim 44, wherein the elliptic curve is characterized by y²+xy=x³+ax²+b over a field of characteristic 2.

54. A method as recited in claim 44, wherein the elliptic curve is defined characterized over a field of characteristic not equal to 2 or 3.

55. A method as recited in claim 44, wherein the elliptic curve is characterized by y²=x³+ax+b over a field of characteristic not equal to 2 or 3.

56. A method as recited in claim 44, wherein the elliptic curve is characterized by y²=x³+ax+b over a field of characteristic 0.

57. A method facilitating the efficiency of a “double-and-add” operation with a collection of points on an elliptic curve, the method comprises combining multiples of one or more points of the collection to produce point S on the elliptic curve.

58. A method as recited in claim 57, wherein at least one coordinate of the point S is not determined.

59. A method as recited in claim 57, wherein the combining comprises adding multiples of one or more points of the collection on the elliptic curve.

60. A method as recited in claim 57, wherein the combining comprises subtracting multiples of one or more points of the collection on the elliptic curve.

61. A method as recited in claim 57, wherein the elliptic curve is defined over a field of characteristic 2.

62. A method as recited in claim 57, wherein the elliptic curve is characterized by y²+xy=x³+ax²+b over a field of characteristic 2.

63. A method as recited in claim 57, wherein the elliptic curve is defined over a field of characteristic 3.

64. A method as recited in claim 57, wherein the elliptic curve is characterized by y²=x³+ax²+bx+c over a field of characteristic 3.

65. A method as recited in claim 57, wherein the elliptic curve is defined over a field of characteristic not equal to 2 or 3.

66. A method as recited in claim 57, wherein the elliptic curve is characterized by y²=x³+ax+b over a field of characteristic not equal to 2 or 3.

67. A method as recited in claim 57, wherein the elliptic curve is characterized by y²=x³+ax+b over a field of characteristic 0.

68. A crypto-system comprising:
a memory comprising a set of computer program instructions; and
a processor coupled to the memory, the processor being configured to execute the computer program instructions facilitating the efficiency of a “double-and-add” operation, where P and Q are points on an elliptic curve, the instructions comprising:
combining point P and point Q to produce point S, wherein fewer than all of the coordinates of point S are determined;
combining point S and point P to produce point T.
